(19) United States
(12) Patent Application Publication
(10) Pub. No.: US 2025/0236358 A1
(43) Pub. Date: Jul. 24, 2025

(54) SYSTEMS AND METHODS FOR SETTING OFFSHORE DEEPLY EMBEDDED ANCHORS

(71) Applicant: The Texas A&M University System, College Station, TX (US)

(72) Inventors: Junho Lee, College Station, TX (US); Charles P. Aubeny, College Station, TX (US)

(73) Assignee: The Texas A&M University System, College Station, TX (US)

(21) Appl. No.: 19/032,583

(22) Filed: Jan. 21, 2025

Related U.S. Application Data
(60) Provisional application No. 63/623,286, filed on Jan. 21, 2024.

(51) Int. Cl. B63B 21/26; B63B 21/50; B63B 35/44

(52) U.S. Cl. CPC B63B 21/26; B63B 21/502; B63B 35/44; B63B 2035/446

(57) ABSTRACT

A deeply embedded anchor installable in a seabed positioned beneath a water column including a foundation connectable to a follower for installing the foundation beneath the seabed. The foundation includes a foundation body extending longitudinally between a first end and an opposing second end, and a keying flap assembly including one or more flaps pivotably coupled to the foundation body, wherein each of the one or more flaps are pivotable relative to the foundation body between a vertical position corresponding to a run-in configuration of the deeply embedded anchor and a horizontal position angularly spaced from the vertical position and corresponding to an installed configuration of the deeply embedded anchor.

### CROSS-REFERENCE TO RELATED APPLICATIONS

This application claims benefit of U.S. provisional patent application Ser. No. 63/623,286 filed Jan. 21, 2024, and entitled “Systems and Methods for Setting Offshore Keyed anchors,” which is hereby incorporated herein by reference in its entirety for all purposes.

### STATEMENT REGARDING FEDERALLY SPONSORED RESEARCH OR DEVELOPMENT

This invention was made with government support under M2203765-PFI-TT awarded by the National Science Foundation (NSF). The government has certain rights in the invention.

### BACKGROUND

Moored floating structures are critical components in offshore engineering, providing stability and operational functionality for various practical applications including, for example, oil and gas extraction, renewable energy generation, and marine research. Particularly, moored floating structures are marine or offshore platforms tethered to the seabed by a mooring system including one or more flexible mooring lines anchored to the seabed to maintain positional stability. The development of moored floating structures stems from the need to operate in deep-water environments where fixed structures (e.g., rigidly anchored to the seabed) are impractical. Applications of moored floating structures include, among others, floating production storage and offloading units (FPSOs), tension leg platforms (TLPs), floating wind turbines, and aquaculture installations.

### BRIEF SUMMARY OF THE DISCLOSURE

An embodiment of a deeply embedded anchor installable in a seabed positioned beneath a water column comprises a foundation connectable to a follower for installing the foundation beneath the seabed, the foundation comprising a foundation body extending longitudinally between a first end and an opposing second end, and a keying flap assembly comprising one or more flaps pivotably coupled to the foundation body, wherein each of the one or more flaps are pivotable relative to the foundation body between a vertical position corresponding to a run-in configuration of the deeply embedded anchor and a horizontal position angularly spaced from the vertical position and corresponding to an installed configuration of the deeply embedded anchor. In some embodiments, the one or more flaps are positioned in an interior of the foundation body. In some embodiments, the one or more flaps cover at least 90% of a cross-sectional area of the interior of the foundation when the one or more flaps are in the horizontal position. In certain embodiments, the foundation body comprises a flap support structure through which the keying flap assembly is coupled to the foundation body. In certain embodiments, the flap support structure is located at the second end of the foundation body. In some embodiments, the flap support structure is located in an interior of the foundation body. In some embodiments, the flap support structure is cruciform in shape. In certain embodiments, the foundation comprises one or more pivot joints connected between the flap support structure and the one or more flaps. In certain embodiments, the flap support structure delimits motion of the one or more flaps in response to the one or more flaps pivoting from the vertical position to the horizontal position. In some embodiments, the deeply embedded anchor comprises the follower, wherein the follower is connected to the foundation when the deeply embedded anchor is in the run-in configuration and is disconnected from the foundation when the deeply embedded anchor is in the installed configuration. An embodiment of a moored floating structure comprises a floating support structure, the deeply embedded anchor, and one or more flexible mooring lines extending between the floating support structure and the deeply embedded anchor. In some embodiments, the moored floating structure comprises an industrial asset supported on the floating support structure.

An embodiment of a deeply embedded anchor installable in a seabed positioned beneath a water column comprises a foundation connectable to a follower for installing the foundation beneath the seabed, the foundation comprising a foundation body comprising an interior and extending longitudinally between a first end and an opposing second end, and a keying flap assembly comprising one or more flaps pivotably coupled to the foundation body, wherein each of the one or more flaps are shiftable relative to the foundation body between a first position corresponding to a run-in configuration of the deeply embedded anchor and a second position spaced from the first position and corresponding to an installed configuration of the deeply embedded anchor in which the one or more flaps cover at least 90% of the surface area of the interior of the foundation body. In certain embodiments, the one or more flaps are located in an interior of the foundation body. In certain embodiments, the foundation body comprises a flap support structure through which the keying flap assembly is coupled to the foundation body. An embodiment of a moored floating structure comprises a floating support structure, the deeply embedded anchor, and one or more flexible mooring lines extending between the floating support structure and the deeply embedded anchor. In some embodiments, the moored floating structure comprises an industrial asset supported on the floating support structure.

An embodiment of a method for installing a deeply embedded anchor of a moored floating structure in a seabed positioned beneath a column of water comprises (a) lowering the deeply embedded anchor towards the seabed whereby a foundation of the deeply embedded anchor penetrates into and through the seabed, (b) applying a vertically upwards force to the deeply embedded anchor following (a) to drive the foundation vertically upwards through the seabed, and (c) pivoting in response to (b) one or more flaps of the foundation from a vertical position to a horizontal position thereby arresting the vertical upward motion of the foundation through the seabed. In some embodiments, the one or more flaps are positioned in an interior of the foundation. In certain embodiments, the one or more flaps cover at least 90% of a cross-sectional area of the interior of the foundation when the one or more flaps are in the horizontal position.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments of the disclosure, reference will now be made to the accompanying drawings in which:

FIG. 1 is a schematic view of an embodiment of a moored floating structure in accordance with principles disclosed herein;

FIG. 2 is an exemplary graph of vertical load capacity as a function of anchor diameter for an exemplary deeply embedded anchor;

FIG. 3 is an exemplary graph of vertical load capacity as a function of anchor diameter for an exemplary deeply embedded anchor;

FIG. 4 is a side view of an embodiment of a deeply embedded anchor in accordance with principles disclosed herein;

FIG. 5 is a side cross-sectional view of an embodiment of a foundation of the deeply embedded anchor of FIG. 4

FIG. 6 is a top view of the foundation of FIG. 5;

FIG. 7 is another side cross-sectional view of the foundation of FIG. 5;

FIG. 8 is a schematic view of an embodiment of an anchor installation vessel in accordance with principles disclosed herein;

FIGS. 9-12 are additional side views of the deeply embedded anchor of FIG. 4;

FIGS. 13 and 14 are side views of another embodiment of a deeply embedded anchor in accordance with principles disclosed herein;

FIG. 15 is an exemplary graph of installation line tension as a function of keying distance in accordance with principles disclosed herein;

FIGS. 16 and 17 are side views of another embodiment of a deeply embedded anchor in accordance with principles disclosed herein;

FIG. 18 is a side view of another embodiment of a deeply embedded anchor in accordance with principles disclosed herein;

FIG. 19 is a side view of another embodiment of a deeply embedded anchor in accordance with principles disclosed herein;

FIG. 20 is block diagram of an embodiment of a computer system in accordance with principles disclosed herein; and

FIG. 21 is flowchart of an embodiment of a method installing a deeply embedded anchor of a moored floating structure in a seabed positioned beneath a column of water in accordance with principles disclosed herein.

### DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Further, as used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, moored floating structures comprise offshore platforms tethered to the seabed by a mooring system including one or more flexible mooring lines anchored to the seabed to maintain positional stability. The configurations of moored floating structures are diverse, each tailored to specific operational needs and environmental conditions. For example, semi-submersibles comprise a form of moored floating structure that rely on submerged pontoons to achieve stability in moderate to deep waters, while spar platforms, another form of moored floating structure, utilize a deep cylindrical hull to remain upright in harsh offshore conditions. Additional forms of moored floating structures include Tension leg platforms (TLPs) and floating offshore wind turbines (FOWTs). TLPs employ vertical mooring tendons, which reduce vertical movement and provide a stable base for operations. Additionally, FOWTs use lightweight and flexible designs optimized for capturing renewable energy in offshore environments.

The mooring systems of moored floating structures play a vital role in the functionality of these structures, anchoring them securely to the seabed. Mooring systems of moored floating structures generally include one or more flexible mooring lines anchored to the seabed using one or more corresponding anchors connected to terminal ends of the one or more mooring lines such that the anchors may resist vertical and/or horizontal loads applied thereto by the mooring lines. However, the configuration of mooring systems of moored floating structures may vary depending on the requirements of the given application. For example, catenary mooring systems use heavy chains or cables as mooring lines with a slack configuration to provide flexibility in shallow and moderate depths. In contrast, the mooring lines of taut-leg mooring systems are pre-tensioned, offering enhanced stability in deeper waters. The choice of mooring materials—ranging from steel chains to synthetic fibers or hybrid composites—depends on environmental conditions and the required load-bearing capacity.

The anchors of such mooring systems provide the foundational connection between the moored floating structure and the seabed. The type of anchor selected depends on factors such as seabed composition, environmental conditions, and the load requirements of the mooring system. Among the various types, embedded anchors comprise anchors of moored floating structures that are physically embedded in the seabed and are thus anchored to the seabed by the resistance of the surrounding soil forming the seabed. Embedded keyed anchors include, among other forms, caissons and multiline ring keyed anchors (MRAs).

MRAs were originally developed for securing FOWTs but are applicable for a variety of offshore applications given their deep embedment into the strong soil of seabeds permits the achievement of high load capacity with an anchor that is comparably smaller and lighter (and thus less expensive) than conventional caissons. The type of anchoring system used may depend on the type and size of the moored floating structure along with water depth, seabed conditions, costs, logistics, maintenance requirements, reliability, safety, and regulatory considerations. Thus, successful deployment of moored floating structures requires innovative, eco-friendly (e.g., generating a limited amount of noise in the marine environment during installation), and cost effective installation systems and methods that are adaptable to a variety of mooring systems, and account for the dynamic marine environment along with challenging weather conditions.

For example, conventional embedded anchors used for clay seabeds include drag anchors, direct embedment plate anchors, dynamically installed anchors, suction caissons, and driven piles. However, conventional embedded anchors face substantial limitations related to cost-effectiveness, environmental impact, and adaptability to different seabed conditions. Particularly, drag anchors involve substantial uncertainty in installation leading to increased cost, while suction caissons have relatively low geotechnical efficiency making them suboptimal for tension leg systems and other high-load applications. Further, direct embedment plate anchors are generally ineffective for inclined loading (e.g., resisting horizontally directed forces applied to the anchor), and uncertainty as to the keying trajectory of suction embedded plate anchors typically make them unsuitable for tension leg mooring systems. Further, dynamically installed anchors, plate anchors and direct pile anchors also encounter limitations such as uncertainty with regard to vertical and horizontal positioning within the seabed, cost, and impact on marine life due to the marine noise generated during their installation.

Accordingly, embodiments of deeply embedded anchors of moored floating structures are described herein that, relative to conventional embedded anchors, are highly efficient, environmentally benign and cost effective and which may be incorporated into shared mooring system to achieve additional cost reduction. Embodiments of deeply embedded anchor are configured to embed at an embedment depth that is relatively deeper than conventional embedded anchors providing said deeply embedded anchors with relatively greater vertical and/or horizontal load capacities with respect to conventional embedded anchors. As used herein, the term “deeply embedded anchors” refers to embedded anchors having a ratio of embedment depth to maximum outer diameter of at least 8.

In an embodiment, a deeply embedded anchor includes a follower and a foundation having an outer surface and an interior surface defining the foundation and a keying flap assembly comprising one or more flaps rotatable between a vertical position to a horizontal position whereby at least 90% of the cross-sectional area of the interior of the foundation is covered by the one or more flaps. In certain embodiments, the one or more flaps travel at least 70 degrees from the vertical position to the horizontal position.

In some embodiments, systems and methods for setting offshore deeply embedded anchors includes applying a force to the follower and the deeply embedded anchor to advance the deeply embedded anchor to a desired embedment depth by pumping fluid out from an interior of the foundation to surface, and applying a reverse force to the follower and the deeply embedded anchor by pumping fluid from the surface into the interior of the foundation thereby creating an extraction force pushing the follower upwards. Additionally, systems and methods for setting offshore deeply embedded anchors includes transitioning the one or more flaps of the keying flap assembly from a vertical position to a horizontal position pivoted from the vertical position in response to the extraction force pushing the follower upwards.

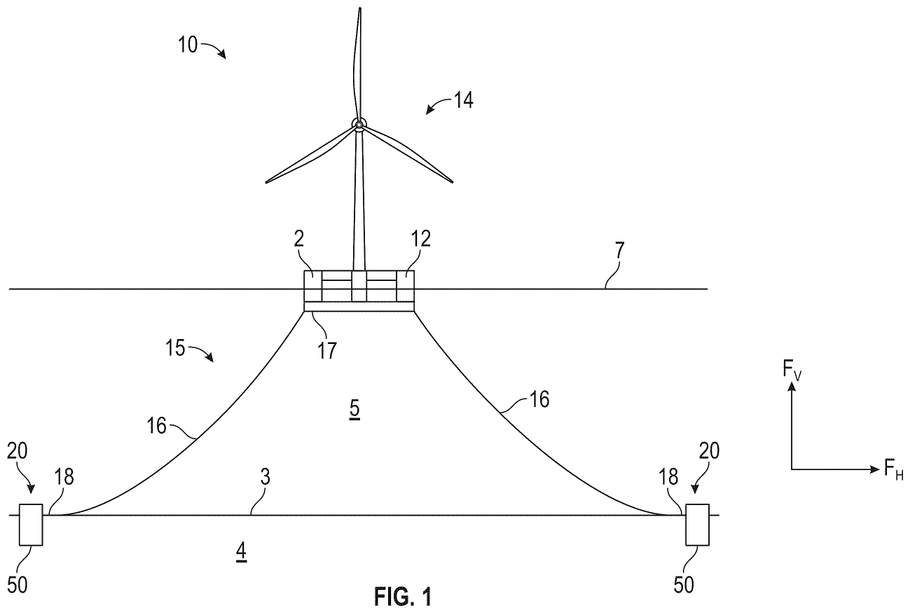

Referring now to FIG. 1, an exemplary embodiment of a moored floating structure 10 positioned along a waterline 7 above a seabed 3 is shown. Particularly, moored floating structure 10 comprises a floating support structure 12 located at the waterline 7, an industrial asset 14 supported on the floating support structure 12 above the waterline 7, and mooring system 15 extending through the water column 5 anchoring the floating support structure 12 to the seabed 3. In this manner, the position and/or orientation of floating support structure 12 may be stabilized via the support provided by mooring system 15. In this exemplary embodiment, the industrial asset 14 supported by floating support structure 12 comprises a FOWT; however, the configuration of industrial asset 14 may vary in other embodiments. For instance, in other embodiments, industrial asset 14 may comprise an offshore drilling system, an offshore production system or plant, an agriculture system, and/or other industrial assets.

The mooring system 15 generally includes including one or more flexible mooring lines 16 and one or more deeply embedded anchors 20 connected thereto and which are anchored to the seabed 3. Moored floating structure 10 is shown in an installed or final configuration following the installation of anchors in the seabed 3. Mooring system 15 may include additional features or components not shown in FIG. 1 that are utilized during the installation thereof. Each mooring line 16 extends between a first or upper end 17 connected to the floating support structure 12, and a second or lower end 18 opposite the upper end 17 and which is connected to a corresponding deeply embedded anchor 20. Each deeply embedded anchor 20 comprises a foundation 50 that is at least partially embedded into the seabed 3 such that the foundation 50 projects into or through the subsurface soil 4 of the seabed 3. Although a pair of mooring lines 16 and a corresponding pair of deeply embedded anchors 20 are shown in FIG. 1, the number of mooring lines 16 and deeply embedded anchors 20 may vary depending on the particular application. Additionally, while mooring system 15 is shown anchoring a single floating support structure 12 to the seabed 3, in other embodiments, mooring system 15 may concurrently anchor more than one floating support structure 12 to the seabed 3. Further, mooring system 15 is shown in FIG. 1 as comprising a catenary mooring system in which both substantial vertically directed forces (indicated by arrow F_{V} in FIG. 1) as well as substantial horizontally directed forces (indicated by arrow F_{H} in FIG. 1) are applied to the anchors 20 thereof. Alternatively, mooring system 15 may comprise mooring systems other than catenary mooring systems such as, for example, semi-taut mooring systems, taut mooring systems, tension leg mooring systems, and length-varying tension-fixed (LVTF) mooring systems.

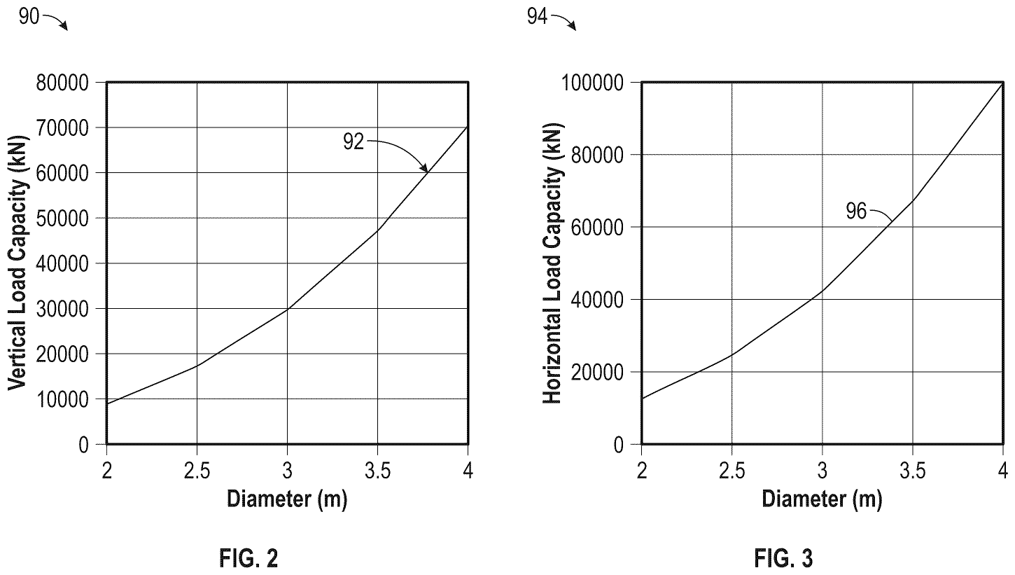

As described above, deeply embedded anchors such as, for example, deeply embedded anchor 20 have performance characteristics that substantially exceed those of conventional embedded anchors including vertical load capacity, horizontal load capacity, and/or other parameters. As an example, and referring to FIGS. 2 and 3, exemplary graphs 90 and 94 are shown. Particularly, graph 90 illustrates vertical load capacity 92 as a function of outer diameter of an exemplary deeply embedded anchor such as deeply embedded anchor 20 shown in FIG. 1. Additionally, graph 94 illustrates horizontal load capacity 96 as a function of outer diameter of an exemplary deeply embedded anchor such as deeply embedded anchor 20. As an illustrative exemplary point of comparison, TABLE 1 is provided below listing different performance characteristics of an exemplary deeply embedded anchor (e.g., deeply embedded anchor 20) as compared with an exemplary conventional embedded anchor. The term “efficiency” referred to in Table 1 refers to the geotechnical efficiency of the different anchors which is a measure of load capacity divided by anchor dry weight. Additionally, “rapid” refers to rapid loading applied to the anchor while “sustained” refers to sustained loading applied to the anchor.

TABLE 1

| | Deeply | Conventional |
|---|---|---|
| Anchor feature | Embedded Anchor | Embedded Anchor |
| Diameter | 3.8 m | 3.6 m |
| Anchor length | 5.7 m | 21.6 m |
| Tip depth | 57 m | 21.6 m |
| Wall thickness | 2.5 cm | 2.5 cm |
| Dry weight | 130 kN (13 mT) | 564 kN (56 mT) |
| Load capacity—rapid | 10,000 kN (1,000 mT) | 10,000 kN (1,000 mT) |
| Load capacity—sustained | 10,000 kN (1,000 mT) | 8,600 kN (860 mT) |
| Efficiency—rapid | 65 | 18 |
| Efficiency—sustained | 65 | 15 |

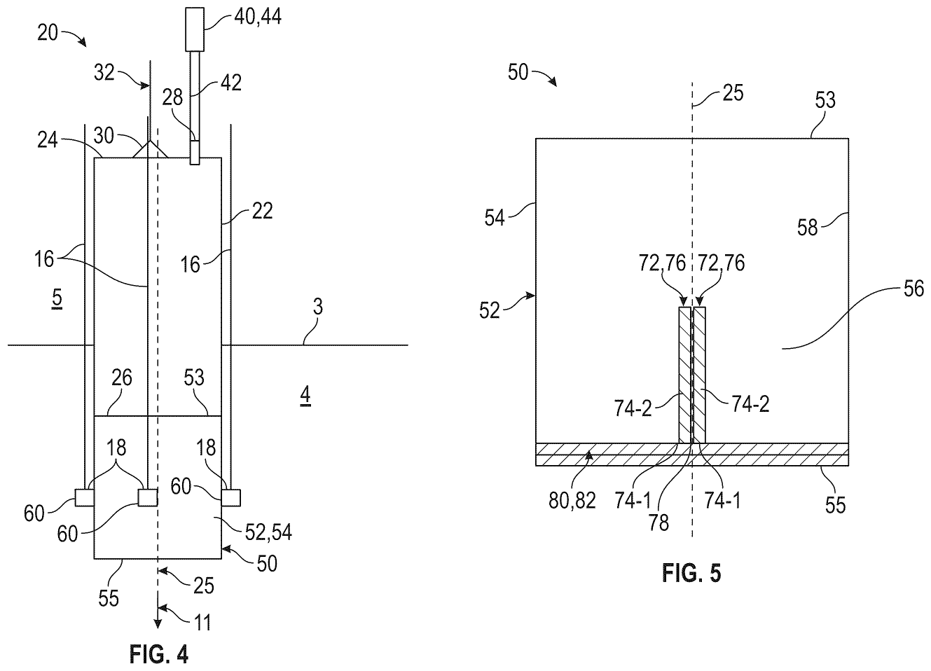

Referring now to FIGS. 4-7, additional views of one of the deeply embedded anchors 20 of moored floating structure 10 shown in FIG. 1 are provided. However, in some embodiments, deeply embedded anchor 20 shown in FIG. 4-6 may be used to anchor moored floating structures other than the moored floating structure 10 shown in FIG. 1. In this exemplary embodiment, deeply embedded anchor 20 has a longitudinal or central axis 25 and generally includes foundation 50 and a follower 22 for installing the foundation 50 within the seabed 3 and which is retrieved to the waterline 7 following the installation of foundation 50. FIG. 4 particularly illustrates deeply embedded anchor 20 during the installation thereof in the seabed 3 with follower 22 coupled to foundation 50.

In this exemplary embodiment, follower 22 of deeply embedded anchor 20 is generally cylindrical extending between an enclosed first or upper end 24 and an open second or lower end 26. Follower 22 has a fluid port 28 at the upper end 27 thereof for providing fluidically connected to a central passage or interior of the follower 22. In this manner, when the lower end 26 of follower 22 is located beneath the seabed 3 as shown in FIG. 4, the fluid pressure within the interior of follower 22 may be controlled via pressurizing or depressurizing the fluid port 22 whereby the fluid pressure within the interior of follower 22 may vary from the fluid pressure in the portion of the water column 5 immediately surrounding the upper end 24 of the follower 22. For example, a pumping system 40 may be fluidically connected to the fluid port 28, the pumping system 40 having a fluid conduit 42 and a fluid pump 44 connected therewith and transportable by a remotely operated underwater vehicle (ROV) and/or via a surface vessel. Pumping system 40 may controllably adjust fluid pressure within the interior of follower 22 to facilitate the installation of deeply embedded anchor 20 at the seabed 3, as will be discussed further herein. In other embodiments, fluid pressure may not be utilized for installing the deeply embedded anchor 20. For instance, in other embodiment, a vibratory tool or hammer may be coupled to the anchor 22 for transmitting cyclical or vibratory forces to the foundation 50 to thereby drive the deeply embedded anchor 20 into and through the seabed 3.

Additionally, follower 22 has a connector or attachment point 30 located at the upper end 28 from an installation line 32 may be connected when lowering the deeply embedded anchor 20 from the waterline 7 towards the seabed 3. Axially directed forces (e.g., tension forces) may be applied to the follower 22 by the installation line 32. For instance, the installation line 32 may extend to a winch positioned on a surface vessel from which the deeply embedded anchor 20 may be lowered through the water column 5.

The lower end 26 of follower 22 is connectable to the foundation 50 of deeply embedded anchor 20 whereby the follower 22 may apply axially directed forces (e.g., directed along central axis 25 of deeply embedded anchor 20) to the foundation 50 during the installation of deeply embedded anchor 20. Particularly, the lower end of follower 22 may be releasably coupled to an upper end of the foundation 50 whereby the follower 22 may apply axially directed forces to the foundation 50 during the installation thereof and subsequently release from the foundation 50 following the installation thereof such that the follower 22 may be retrieved to the surface leaving the foundation 50 embedded in and anchored to the seabed 3.

In this exemplary embodiment, foundation 50 of deeply embedded anchor 20 includes a generally cylindrical or tubular foundation body 52 and a keying flap assembly 70 pivotably coupled to the foundation body 52. In this exemplary embodiment, foundation body 52 of deeply embedded anchor 20 includes a first or upper end 53, a second or lower end 55, an outer surface 54 extending between ends 53 and 55, and an interior or central passage 56 defined by a generally cylindrical inner surface 58 extending between ends 53 and 55. In this exemplary embodiment, the plurality of mooring lines 16 are coupled to the foundation body 52 by a plurality of cable connectors 60 circumferentially spaced about the outer surface 54 of foundation body 52. In this exemplary embodiment, cable connectors 60 of foundation body 52 comprise pad-eyes and thus may also be referred to as pad-eyes 60 herein. In this configuration, tension may be transmitted from the mooring lines 16 to the foundation body 52 via the plurality of cable connectors 60 coupled therebetween. Mooring lines 16 may comprise metallic chains in some embodiments, but may alternatively comprise various materials (e.g., polymer-containing materials) and alternating configurations in other embodiments. Additionally, the circumferential spacing of cable connectors 60 ensures the tension applied to foundation body 52 by mooring lines 16 following activation or setting of deeply embedded anchor 20 is symmetrical about the circumference of the foundation body 52. Further, although three cable connectors 60 are shown in FIG. 4, the number of cable connectors 60 of foundation body 52 may vary in other embodiments.

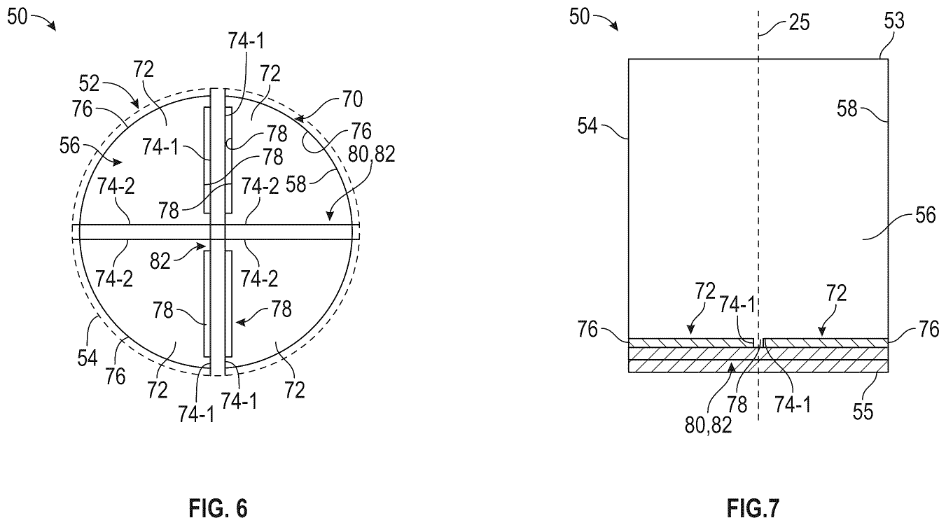

Keying flap assembly 70 of foundation 50 comprises one or more separate pie-shaped flaps 72 and a flap support structure 80 coupled to the foundation body 52 whereby relevant movement between flap support structure 80 and foundation body 52 is restricted. Each flap 72 of flap assembly 70 is defined by a pair of inner ends 74 (shown as 74-1 and 74-2) and an opposing outer or free end 76 and is pivotably connected to the flap support structure 80 via a pivot joint 78 connected between the inner end 74-1 of each flap 72 and the flap support structure 80. In some embodiments, pivot joints 78 comprise hinges and thus may also be referred to herein as hinges 80. Although flaps 72 are shown as pie-shaped in FIG. 6, the shape or configuration of flaps 72 may vary in other embodiments. Additionally, while four separate flaps 72 are shown in FIG. 6, the number and arrangement of flaps 72 may vary in other embodiments.

In this exemplary embodiment, flap support structure 80 is located at the lower end 55 of foundation body 52 and comprises a pair of orthogonally extending support members or stiffener plates 82. Particularly, each of the stiffener plates 82 is positioned within the interior 56 of foundation body 52 and extends laterally (generally orthogonal with central axis 25). Stiffener plates 82 is cruciform in this exemplary embodiment, but it may be understood that the shape and configuration of stiffener plates 82 may vary in other embodiments. For instance, in some embodiments, foundation body 52 may comprise a single ring-shaped or annular flap support structure positioned along the interior surface 58 of foundation body 52.

In some embodiments, stiffener plates 82 may be formed integrally or monolithically with the foundation body 52 whereby stiffener plates 82 comprise a portion of the foundation body 52. In this exemplary embodiment, stiffener plates 82 are attached to the inner surface 58 of foundation body 52 such as by bonding (e.g., welding), through the use of one or more fasteners, or other means. Additionally, in this exemplary embodiment, each stiffener plate 82 has a longitudinal length that is approximately equal to the inner diameter of foundation body 52 (defined by inner surface 58); however, in other embodiments, the longitudinal length of stiffener plates 82 may be less than the inner diameter of the foundation body 52.

In this exemplary embodiment, the flaps 72 of keying flap assembly 70 are pivotably coupled to stiffener plates 82 whereby each flap 72 is pivotable between a vertical position (shown in FIG. 5) corresponding to a run-in configuration of deeply embedded anchor 20, and a horizontal position (shown in FIGS. 6 and 7) angularly spaced from the vertical position and associated with an installed configuration of the deeply embedded anchor 20. Particularly, each flap 72 of keying flap assembly 70 is separately pivotable about their respective pivot joints 78 with each pivot joint 78 defining a pivot axis of the respective flap 72 to which the pivot joint 78 is coupled. In this exemplary embodiment, the pivot axes defined by pivot joints 78 extend generally horizontal and orthogonal to the central axis 25 of deeply embedded anchor 20. In some embodiments, the vertical positions of flaps 72 may not be exactly parallel (e.g., at a non-zero angle) from the longitudinal axis 25 and/or the horizontal positions of flaps 72 may not be exactly orthogonal (e.g., at a non-zero angle) from the longitudinal axis 25. However, the horizontal positions of flaps 72 are angularly spaced (by a non-zero angle) from their vertical positions, as will be discussed further herein.

In the vertical position of flaps 72 the outer ends 76 of flaps 72 are spaced from the inner surface 58 of foundation body 52. Conversely, in the horizontal position, the outer ends 76 of flaps 72 are positioned directly adjacent the inner surface 58 of foundation body 52. In this manner, a flow area of the foundation 50 extending through the interior 56 of foundation body 52 changes depending on whether flaps 72 are in the horizontal or vertical positions. The flow area through the interior 56 of foundation 50 is negatively correlated with a cumulative axially-projected surface area of the flaps 72 which also varies depending on whether flaps 72 are in their horizontal positions or their vertical positions. Particularly, foundation 50 has a first flow area when flaps 72 are in their horizontal positions that is less than a flow area of foundation 50 when flaps 72 are in their vertical positions. For instance, the flow area of foundation 50 may be near or at zero percent of the cross-sectional area of the interior 56 of foundation body 52 when flaps 72 are in their horizontal positions, and greater than 50% of the cross-sectional area of the interior 56 when flaps 72 are in their vertical positions. In some embodiments, the flow area of interior 56 is greater than 75% of the cross-sectional area of the interior 56 when flaps 72 are in their vertical positions. In some embodiments, the flow area of interior 56 is greater than 90% of the cross-sectional area of the interior 56 when flaps 72 are in their vertical positions. As will be discussed further herein, the resistance to axial movement of foundation 50 through the soil 4 beneath seabed 3 is correlated with the flow area of interior 56 whereby the resistance to axial movement of foundation 50 relative seabed 3 may be significantly increased by shifting flaps 72 from their vertical positions to their horizontal positions. In other words, the resistance to axial movement of foundation 50 relative to seabed 3 increases significantly in response to shifting deeply embedded anchor 20 from the run-in configuration to the installed configuration.

Deeply embedded anchor 20 may be transitioned from its run-in configuration to its installed configuration with flaps 72 shifting from their vertical to their horizontal positions using a variety of different predefined triggering mechanisms that may be applied at the waterline 7 far above the seabed 3. For example, such triggering mechanisms may be mechanical, electrical, fluidic, and/or combinations thereof. In this exemplary embodiment, pumping system 40 may be used to create an embedment force for driving the anchor vertically downwards through the soil 4 beneath the seabed 3 to a desired embedment depth beneath seabed 3. For instance, pumping system 40 may depressurize or induce a negative pressure (relative to the surrounding ambient environment) in the interior 56 of foundation 50 such that a pressure differential is formed across the upper end 24 of follower 22 such that the relatively fluid pressure pressing vertically downwards against the upper end 24 of follower 22 drives the deeply embedded anchor 20 downwards and through the seabed 3 to the desired embedment depth.

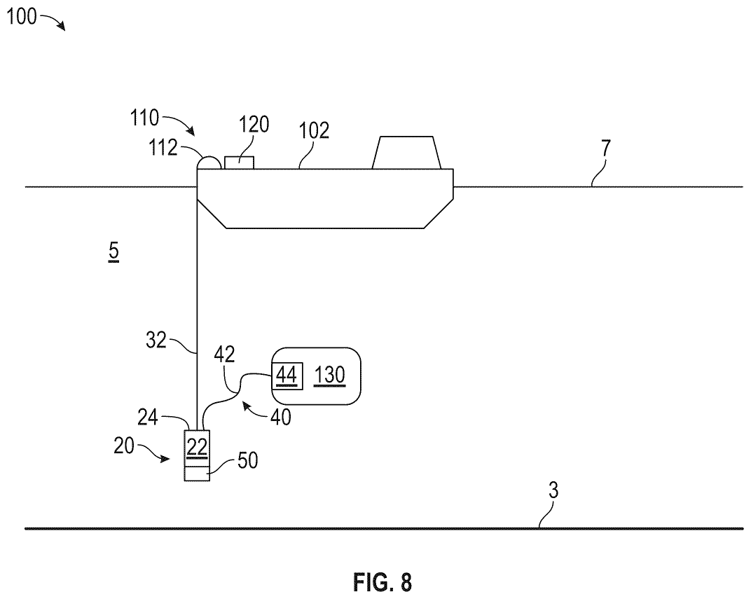

Referring to FIG. 8, an embodiment of a anchor installation or handling vessel 100 for installing deeply embedded anchor 20 is shown. Particularly, anchor installation vessel 100 is located at waterline 7 of the water column 5. Deeply embedded anchor 20 is suspended from the anchor installation vessel 100 by the installation line 32 coupled to follower 22 of deeply embedded anchor 20. Anchor installation vessel 100 is particularly configured to facilitate extraction of follower 22 after installation of deeply embedded anchor 20. In some embodiments, anchor installation vessel 100 may be configured to facilitate the installation of deeply embedded anchor 20 by applying a tension or extraction force to installation line 32 coupled to follower 22 of deeply embedded anchor 20.

In this exemplary embodiment, anchor installation vessel 100 includes a deck 102, and a winch assembly 110 supported on the deck 102. The winch assembly 110 of anchor installation vessel 100 connects the anchor installation vessel 100 with the deeply embedded anchor 20 via the installation line 32. Particularly, winch assembly 110 comprises one or more winches 112 connected to the installation line 32 of the deeply embedded anchor 20 whereby the installation line 32 extends vertically through the water column 5 from the follower 22 to the winch 112 of anchor handing vessel 100. During installation of deeply embedded anchor 20, winch 112 may apply a tensile extraction force through the installation 32 to the follower 22 to disconnect the follower 22 from the installed foundation 50 for retrieval to the anchor installation vessel 100. While in this exemplary embodiment winch assembly 110 is used to apply tension to installation line 32, it may be understood that other means may be used in other embodiments for applying an extraction force to installation line 32.

Deeply embedded anchor 20 is additionally coupled to a ROV 130 through the pumping system 40 where fluid pump 44 comprises a pump of the ROV 130 and which is fluidically connected to the deeply embedded anchor 20 through the fluid conduit 42 extending therebetween. As described above, pumping system 44 may be used to control an internal fluid pressure within the deeply embedded anchor 20 to facilitate the installation of deeply embedded anchor 20 in the seabed 3. Although pumping system 40 is shown incorporated in ROV in this exemplary embodiment, in other embodiments, pumping system 40 may instead be incorporated in anchor installation vessel 100.

The winch assembly 110 of anchor installation vessel 100 additionally includes a surface controller 120 configured to control the operation of the winch 112 (e.g., control the operation of one or more motors of the winch 112) of winch assembly 110. In some embodiments, surface controller 120 may control the operation of pumping system 40 through the ROV 130. Particularly, surface controller 120 comprises a computer or computing system and is configured to monitor and potentially control the amount of tension applied to installation line 32 and hence the amount of vertically directed load or extraction force applied to the follower 22 by the winch 112, and/or the amount of pressure extracted from or applied to the interior of the follower 22 and hence the amount of vertically directed embedment force applied by the follower 22 to foundation body 52. In some embodiments, the surface controller 120 is controlled by a human operator. However, in other embodiments, surface controller 120 may control the operation of winch 112 at least semi-autonomously, minimizing the need for personnel onboard the anchor installation vessel 100. It should be noted that winch 112 may be required to lift the follower 22 from the seabed 3 to the anchor installation vessel 100.

By adjusting pressure within the interior of follower 22, the surface controller 120 may control the pressure differential across the upper end 24 of follower 22 and the concomitant embedment force applied thereto. By controlling said pressure differential, surface controller 120 may control both the magnitude and vertical direction of the axially directed force applied by the follower 22 to the deeply embedded anchor 20. For instance, by creating a partial vacuum within the interior of follower 22, surface controller 120 (through controlling the operation of pumping system 40) may create a negative pressure differential across the upper end 24 of follower 22 whereby the greater fluid pressure above the upper end 24 of follower 22 (relative to fluid pressure within the interior of follower 22) applies a vertically downwards directed force against the deeply embedded anchor 20. Conversely, by increasing fluid pressure within the interior of follower 22 such that a positive pressure differential is formed across the upper end 24 thereof (e.g., fluid pressure directly above the upper end 24 of follower 22 is less than fluid pressure within the interior of follower 22) such that a vertically upwards force or extraction force is applied to the follower 20.

Referring again to FIGS. 4-7, FIGS. 4 and 5 particularly illustrate deeply embedded anchor 20 in the run-in configuration prior to the installation or setting of the deeply embedded anchor 20. FIG. 4 illustrates the deeply embedded anchor 20 following penetration of the foundation body 52 into and through the seabed 3 where the vertically downwards direction of travel of foundation body 52 is indicated by arrow 11 in FIG. 4. In some embodiments, the weight of deeply embedded anchor 20 and its attendant momentum may be relied on, without the assistance of pumping system 40, for creating an embedment force sufficient for driving the anchor through the seabed 3 to the desired embedment depth beneath the seabed 3. For instance, in applications where deeply embedded anchor 20 has a relatively great weight, where the soil 4 underlying seabed 3 is relatively soft, and/or where the desired embedment depth is at a relatively minimal distance from the seabed 3, the weight of deeply embedded anchor 20 alone may be sufficient for driving deeply embedded anchor 20 to the desired embedment depth. Thus, in some embodiments, pumping system 40 may only be utilized in application in which the weight of deeply embedded anchor 20 is insufficient for generating the required embedment force. In such applications, pumping system 40 is utilized to create a negative pressure within the interior of deeply embedded anchor 20 to fluidically drive deeply embedded anchor 20 to the desired embedment depth.

As foundation body 52 and follower 22 travel downwards towards the embedment depth, flaps 72 of keying flap assembly 70 remains in their vertical positions associated with the run-in configuration of the deeply embedded anchor 20. In their respective vertical positions, as shown particularly in FIG. 5, the one or more flaps 72 are oriented in a substantially vertical direction. In this arrangement, flaps 72 and keying flap assembly 70 have a minimum axially-projected surface area oriented in the substantially vertical direction generally parallel to the central axis 25 of deeply embedded anchor 20. The resistance to vertical travel of deeply embedded anchor 20 through the soil 4 underlying seabed 3 is contingent on the axially-projected surface area of keying flap assembly 70. Thus, by minimizing the axially-projected surface area of keying flap assembly 70 when flaps 72 are in their vertical positions, the resistance to vertical travel of the foundation body 52 through the subsurface region is concomitantly minimized.

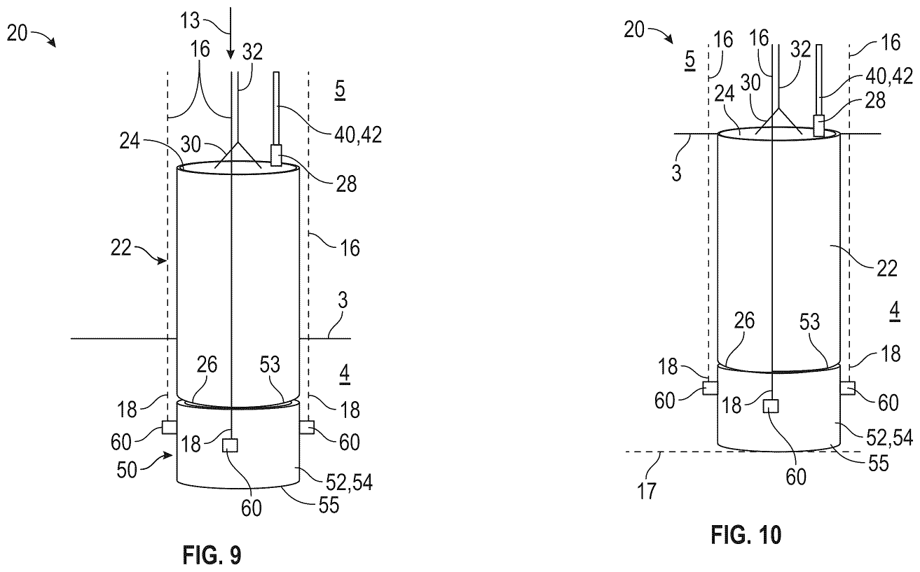

Referring now to FIGS. 9-12, an exemplary method of installing deeply embedded anchor 20 at a desired depth beneath the seabed 3 is shown. Beginning at FIG. 9, deeply embedded anchor 20 is shown in the run-in configuration after initially penetrating the seabed 3 and travelling in a vertically downwards direction indicated by arrow 13 in FIG. 9. In FIG. 9 pumping system 40 has yet to be activate to create a pressure differential across the upper end 24 of follower 22 with only the weight of deeply embedded anchor 20 and its attendant momentum permitting deeply embedded anchor 20 to penetrate the seabed 3.

Following the initial penetration of deeply embedded anchor 20 into the seabed 3 as shown in FIG. 9, the pumping system 40 is activated (e.g., via ROV 130 or via anchor installation vessel 100) to reduce the fluid pressure within the interior of follower 22 and the interior 56 of foundation 50 which is in fluid communication with the interior of follower 22. As shown particularly in FIG. 10, the depressurization of the interior of follower 22 produces a pressure differential across the upper end 24 of follower 22, turning the upper end 24 of follower 22 into a piston whereby an axially directed fluid pressure force applied to upper end 24 drives the deeply embedded anchor 20 further into the seabed 3 until the foundation 50 (e.g., the lower end 55 of foundation 55) achieves a predefined maximum penetration depth 17 beneath the seabed 3.

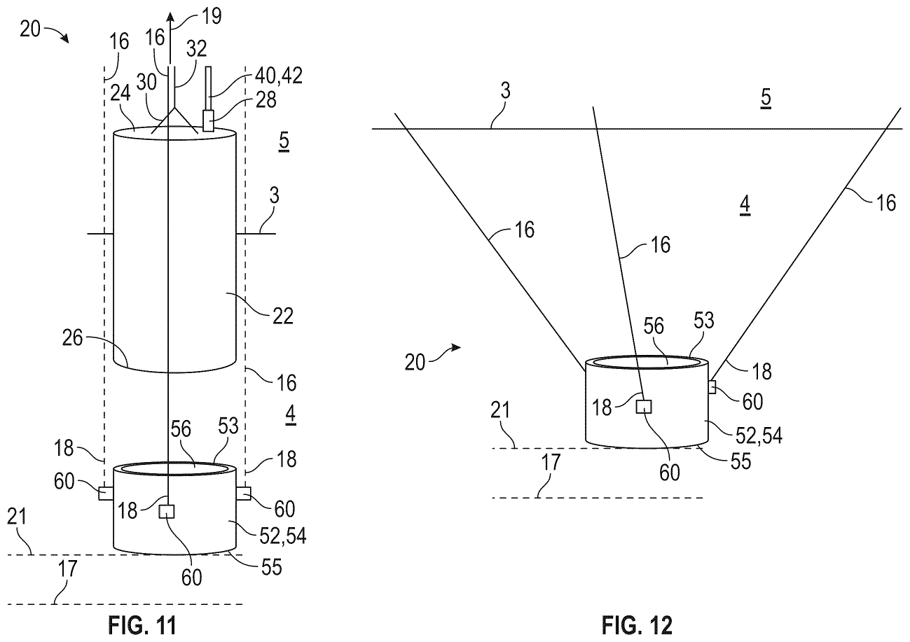

As shown particularly in FIG. 11, in some embodiments, once deeply embedded anchor 20 has reached its embedment depth 17, pumping system 40 is again activated to increase pressure within the interior of follower 22 until fluid pressure within the interior of follower 22 exceeds the fluid pressure in the water column 5 immediately surrounding follower 22. The increased pressure within the interior of follower 22 creates a pressure differential across the upper end 24 thereof that is reversed from the earlier created pressure differential whereby a vertically upwards axially directed pressure force is applied to the upper end 24, causing follower 22 and the foundation 50 to travel vertically upwards as indicated by arrow 19 in FIG. 11. This vertically upwards force pushes the deeply embedded anchor 20 and follower 22 upwards to “key” or set the keying flap assembly 70 ceasing the upward travel of foundation 50 (resulting in the separation of follower 22 from foundation 50) at an embedment depth 21 that is vertically above the maximum penetration depth 17. In other embodiments, rather than creating the vertically upwards force fluidically via pumping system 40, the vertically upwards force may instead be applied by applying a tensile force to the installation line 32 to thereby force the follower 22 vertically upwards. In some embodiments, both a tensile force applied to installation line 32 and a fluid pressure force applied by pumping system 40 may be utilized for transitioning the deeply embedded anchor 20 from the run-in configuration to the installed configuration.

Particularly, in response to the vertically upward force applied to the deeply embedded anchor 20, the one or more flaps 72 pivot from their vertical positions to their horizontal positions as the soil 4 trapped within the interior 56 of foundation 50 applies a rotational torque to the flaps 72 forcing them into their horizontal positions. In some embodiments, at least 90% of the cross-sectional area of the interior 56 of foundation 50 is covered by the one or more flaps 72 when flaps 72 are in their horizontal positions associated with the installed configuration of the deeply embedded anchor 20. In certain embodiments, flaps 72 cover at least 95% of the cross-sectional area of the interior 56 of foundation 50 when in their horizontal positions. In certain embodiments, flaps 72 cover at least 99% of the cross-sectional area of the interior 56 of foundation 50 when in their horizontal positions. In some embodiments, flaps 72 travel at least 60 degrees about their laterally extending rotational axes from their vertical positions to their horizontal positions. In some embodiments, flaps 72 travel at least 75 degrees about their laterally extending rotational axes from their vertical positions to their horizontal positions. In some embodiments, flaps 72 travel approximately 90 degrees about their laterally extending rotational axes from their vertical positions to their horizontal positions.

As flaps 72 rotate from their vertical positions towards their horizontal positions, the one or more flaps 72 experience a hard stop as they encounter stiffener plates 82 which cease or delimit their rotation about their respective rotational axes. The substantial increase in cross-sectional area of the interior 56 of foundation body 52 covered by flaps 72 when in their horizontal positions causes a sudden and sharp increase in resistance to the vertically upward travel of deeply embedded anchor 20 whereby follower 22 releases or decouples from the now set deeply embedded anchor 20 and continues to travel vertically upwards (without deeply embedded anchor 20) as shown in FIG. 11. The one or more flaps 72 may trap a plug of soil in the interior 56 of foundation body 52 to thereby secure deeply embedded anchor 20 beneath the seabed 3 following the retrieval of follower 22 to the waterline 7 as shown particularly in FIG. 12.

The lower end 24 of follower 22 may be frangibly coupled to the upper end 53 of foundation 55 whereby follower 22 is configured to decouple from foundation 50 in response to the application of a threshold vertically upwards force to the follower 22. For instance, the follower 22 may be welded or otherwise joined to the foundation 50 in a manner configured to decouple or break apart in response to the application of the threshold vertically upwards force. In other embodiments, follower 22 may be releasably coupled to foundation 50 via one or more distinct connectors configured to release but not necessarily break apart in response to the application of the threshold vertically upwards force.

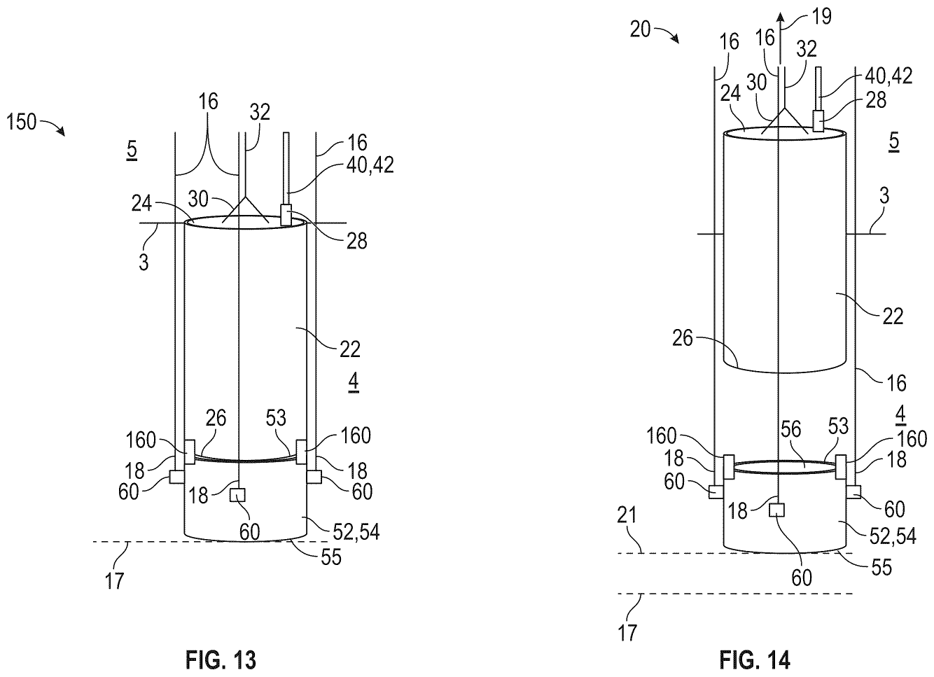

Referring to FIGS. 13 and 14, another embodiment of a deeply embedded anchor 150 is shown. Deeply embedded anchor 150 shares features in common with deeply embedded anchor 20 shown in FIGS. 1-12, and shared features are labeled similarly. Particularly, deeply embedded anchor 150 is similar to deeply embedded anchor 20 except that deeply embedded anchor 150 additionally includes one or more releasable connectors 160 initially coupling the follower 22 with the foundation 50 of deeply embedded anchor 150 when deeply embedded anchor 150 is in the run-in configuration, as shown particularly in FIG. 13. Releasable connectors 160 are permanently coupled to foundation 50 in this exemplary embodiment, but are configured to release from follower 22 in response to the application of the threshold vertically upwards force to follower 22, as shown particularly in FIG. 14.

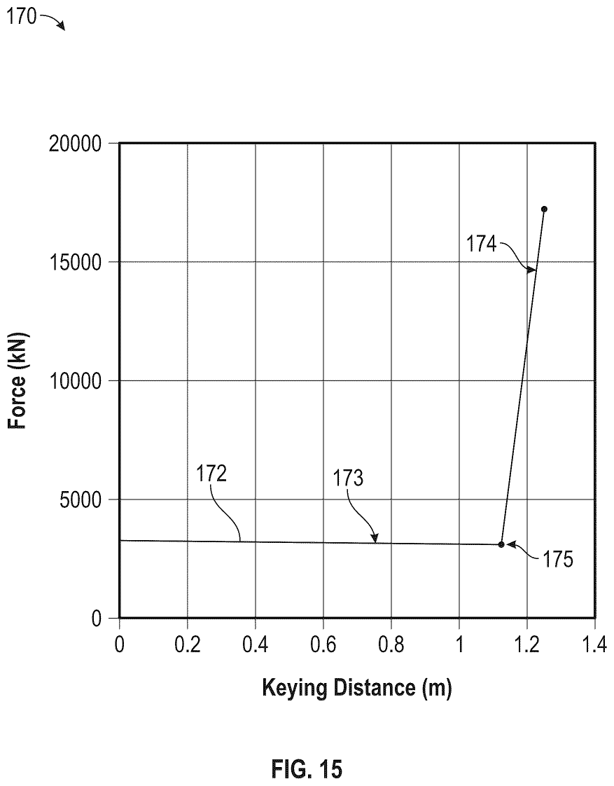

Returning briefly to FIG. 8, as described above, the transition of the deeply embedded anchor 20 from the run-in configuration to the installed configuration may be automatically registered in at least some embodiments at the surface such as by the surface controller 120 of anchor installation vessel 100 and/or by personnel of anchor installation vessel 100. For example, and referring briefly to FIG. 15, a graph 170 is shown illustrating exemplary force or tension 172 applied to the installation line 32 during the installation of deeply embedded anchor 20 as depicted, for example, in FIGS. 9-12. Particularly, tension 172 is shown in graph 170 as a function of keying distance or, in other words, the distance between the maximum penetration depth (shown as 0.0 m along the X-axis of graph 170) and the embedment depth (shown as approximately 1.23 m in graph 170). Additionally, in this example, arrow 173 in graph 170 indicates the position of foundation 50 at which flaps 72 initial pivoting from their vertical positions to their horizontal positions while arrow 174 indicates the point at which flaps 72 enter their horizontal positions. Tension 172 spikes (indicated by arrow 175) at a point between the initiation of pivoting at arrow 173 and the completion of pivoting at arrow 174, where spike 175 may be registered at the waterline 7 (e.g., by surface controller 120) as a positive indication of the successful shifting of flaps 72 from their vertical positions to their horizontal positions and the successful transitioning of deeply embedded anchor 20 from its run-in configuration to its installed configuration.

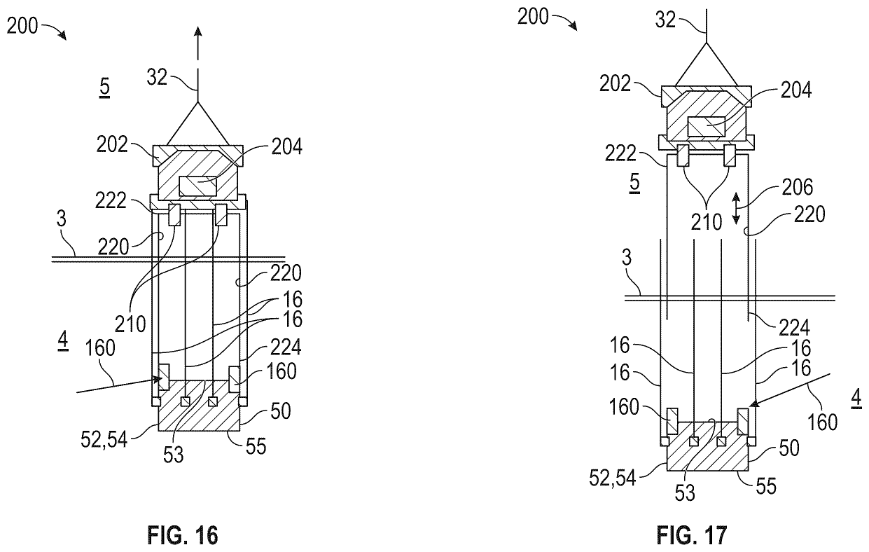

Referring now to FIGS. 16 and 17, another embodiment of a deeply embedded anchor 200 for anchoring a moored floating structure (e.g., moored floating structure 10 shown in FIG. 1) to seabed 3 positioned beneath a water column 5 is shown. Deeply embedded anchor 200 includes features in common with deeply embedded anchor 20 shown in FIGS. 1-12, and shared features are labeled similarly. In this exemplary embodiment, deeply embedded anchor 200 generally includes a vibratory tool or hammer 202, one or more connectors or clamps 210, a follower 220, and foundation 50. Follower 220 extends between an enclosed first or upper end 222 connected to vibratory tool 202 via clamps 210 and an open second or lower end 224 releasably coupled to foundation by connectors 160.

In this exemplary embodiment, vibratory tool 202 may be utilized to impart the axially directed forces through the follower 220 to the foundation 50 to install the foundation at a desired embedment depth beneath the seabed 3. Particularly, vibratory tool 202 comprises a reciprocating actuator 204 configured to induce cyclic or reciprocating motion 206 in the deeply embedded anchor 200 to drive deeply embedded anchor 200 to a desired maximum penetration depth at which point a vertically upwards force may be applied to follower 220 (e.g., via tension applied to installation line 32 and/or positive pressure introduced into an interior of follower 220) to shift the flaps 72 of foundation 50 from their vertical positions to their horizontal positions thereby setting the foundation at the desired embedment depth with deeply embedded anchor 200 in the installed configuration.

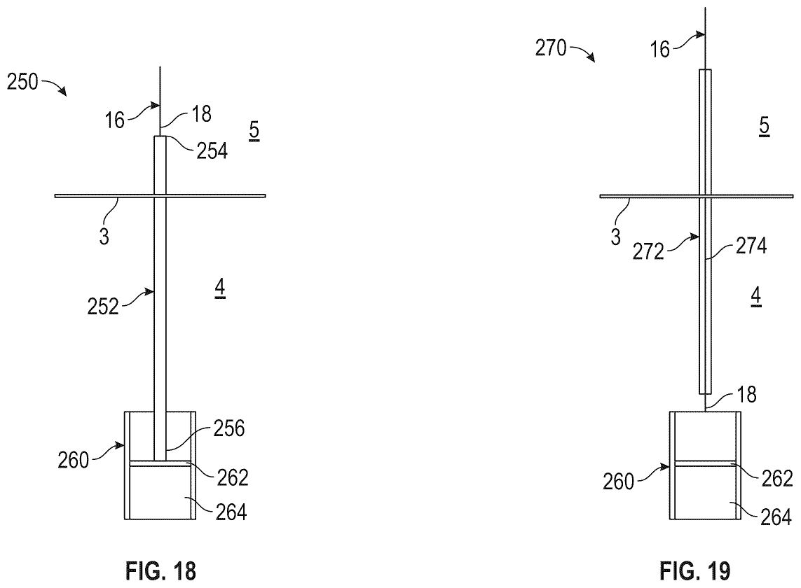

Although the follower 220 of deeply embedded anchor 200, along with other followers discussed herein, have been shown having an outer diameter similar to or greater than the outer diameter of foundation 50, in other embodiments, the outer diameter of the follower may be less than the inner diameter of its corresponding foundation whereby the follower may be at least partially insertable into the foundation during installation of the deeply embedded anchor. For example, and referring now to FIG. 18, another embodiment of a deeply embedded anchor 250 for anchoring a moored floating structure (e.g., moored floating structure 10 shown in FIG. 1) to seabed 3 positioned beneath a water column 5 is shown. Deeply embedded anchor 250 includes features in common with deeply embedded anchor 20 shown in FIGS. 1-12, and shared features are labeled similarly.

In this exemplary embodiment, deeply embedded anchor 250 generally includes a follower 252 and a foundation 260. Follower 252 extends longitudinally between a first or upper end 254 and a second or lower end 256. The lower end 18 of mooring line 16 connects to the upper end 254 of follower 252 with follower 252 remaining permanently connected to foundation 260 at the seabed 3 following installation of deeply embedded anchor 250. Additionally, foundation 260 is similar to the foundation 50 shown in FIGS. 1-12 except that foundation 260 includes an internal follower connector 262 located within a central passage or interior 264 of foundation 260 (keying flap assembly 70 of foundation 260 being hidden from view in FIG. 18). In this exemplary embodiment, the lower end 256 of follower 252 is received in the interior 264 of foundation 260 and is connected to the follower connector 262 of foundation 260. As shown in FIG. 18, follower 252 has a smaller outer diameter than the inner diameter of foundation 260 such that follower 252 is insertable into the interior 264 of foundation 260. In some embodiments, follower 252 may comprise a solid rod or member rather than a hollow or tubular member.

Referring briefly to FIG. 19, another embodiment of a deeply embedded anchor 270 is shown. Particularly, deeply embedded anchor 270 is similar to deeply embedded anchor 250 shown in FIG. 18 except that a follower 272 of deeply embedded anchor 270 is releasably rather than permanently coupled to the foundation 260 at the follower connector 262 thereof. In this exemplary embodiment, follower 272 may be retracted to the waterline 7 with mooring line extending through a central passage 274 of follower and connected directly to the foundation 260 rather than through the follower 272 as with deeply embedded anchor 250 shown in FIG. 18.

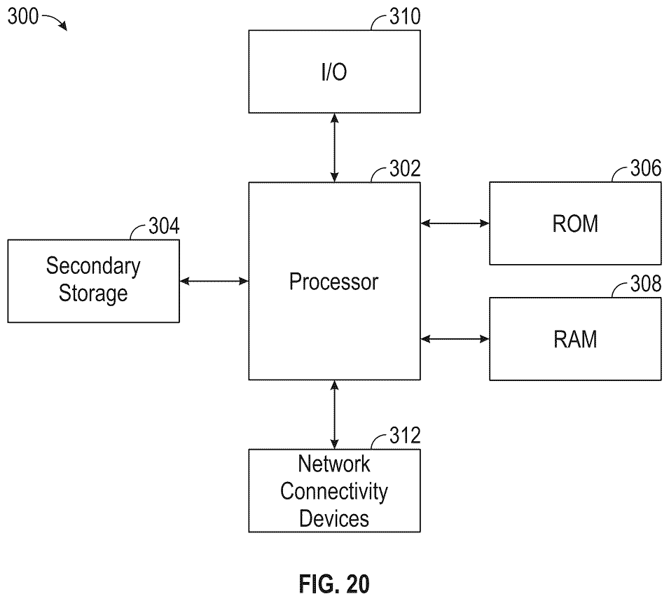

As described above, the surface controller used to facilitate and monitor installation of the anchoring system (e.g., deeply embedded anchors 20, 150, 200, 250, and 270) comprises a computer system. As an example, and referring to FIG. 20, an embodiment of a computer system 300 is shown suitable for implementing one or more embodiments disclosed herein. For example, the surface controller 120 of FIG. 8 may comprise the computer system 300 or at least some of the features of computer system 300. The computer system 300 of FIG. 20 includes a processor 302 (which may be referred to as a central processor unit or CPU) that is in communication with memory devices including secondary storage 304, read only memory (ROM) 306, random access memory (RAM) 308, input/output (I/O) devices 310, and network connectivity devices 312. The processor 302 may be implemented as one or more CPU chips. It is understood that by programming and/or loading executable instructions onto the computer system 300, at least one of the CPU 302, the RAM 308, and the ROM 306 are changed, transforming the computer system 300 in part into a particular machine or apparatus having the novel functionality taught by the present disclosure.

Additionally, after the system 300 is turned on or booted, the CPU 302 may execute a computer program or application. For example, the CPU 302 may execute software or firmware stored in the ROM 306 or stored in the RAM 308. In some cases, on boot and/or when the application is initiated, the CPU 302 may copy the application or portions of the application from the secondary storage 304 to the RAM 308 or to memory space within the CPU 302 itself, and the CPU 302 may then execute instructions that the application is comprised of. In some cases, the CPU 302 may copy the application or portions of the application from memory accessed via the network connectivity devices 312 or via the I/O devices 310 to the RAM 308 or to memory space within the CPU 302, and the CPU 302 may then execute instructions that the application is comprised of. During execution, an application may load instructions into the CPU 302, for example load some of the instructions of the application into a cache of the CPU 302. In some contexts, an application that is executed may be said to configure the CPU 302 to do something, e.g., to configure the CPU 302 to perform the function or functions promoted by the subject application. When the CPU 302 is configured in this way by the application, the CPU 302 becomes a specific purpose computer or a specific purpose machine.

Secondary storage 304 may be used to store programs which are loaded into RAM 308 when such programs are selected for execution. The ROM 306 is used to store instructions and perhaps data which are read during program execution. ROM 306 is a non-volatile memory device which typically has a small memory capacity relative to the larger memory capacity of secondary storage 304. The secondary storage 304, the RAM 308, and/or the ROM 306 may be referred to in some contexts as computer readable storage media and/or non-transitory computer readable media. I/O devices 310 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 312 may take the form of modems, modem banks, Ethernet cards, universal serial bus (USB) interface cards, wireless local area network (WLAN) cards, radio transceiver cards, and/or other well-known network devices. The network connectivity devices 312 may provide wired communication links and/or wireless communication links. These network connectivity devices 312 may enable the processor 302 to communicate with the Internet or one or more intranets. With such a network connection, it is contemplated that the processor 302 might receive information from the network, or might output information to the network. Such information, which may include data or instructions to be executed using processor 302 for example, may be received from and outputted to the network, for example, in the form of a computer data baseband signal or signal embodied in a carrier wave.

The processor 302 executes instructions, codes, computer programs, scripts which it accesses from hard disk, floppy disk, optical disk, flash drive, ROM 306, RAM 308, or the network connectivity devices 312. While only one processor 302 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 304, for example, hard drives, floppy disks, optical disks, and/or other device, the ROM 306, and/or the RAM 308 may be referred to in some contexts as non-transitory instructions and/or non-transitory information.

In an embodiment, the computer system 300 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, the functionality disclosed above may be provided by executing the application and/or applications in a cloud computing environment. Cloud computing may comprise providing computing services via a network connection using dynamically scalable computing resources.

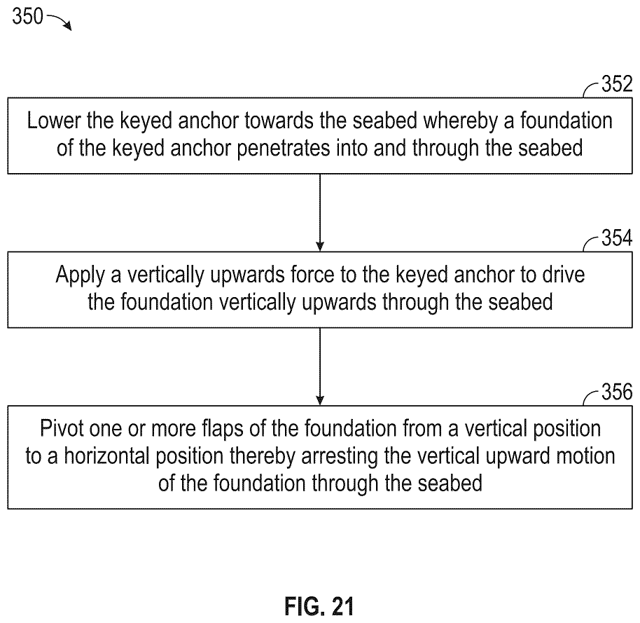

Referring to FIG. 21, an embodiment of a method 350 for installing a deeply embedded anchor (e.g., deeply embedded anchor 20 shown in FIGS. 1-12) of a moored floating structure (e.g., moored floating structure 10 shown in FIG. 1) in a seabed (e.g., seabed 3 shown in FIG. 1) positioned beneath a column of water (e.g., water column 4 shown in FIG. 1). Initially, at block 352, method 350 includes lowering the deeply embedded anchor towards the seabed whereby a foundation (e.g., foundation 50 shown in FIGS. 1-12) of the deeply embedded anchor penetrates into and through the seabed. At block 354, method 350 includes applying a vertically upwards force to the deeply embedded anchor following to drive the foundation vertically upwards through the seabed. At block 356, method 350 includes pivoting one or more flaps (e.g., one or more flaps 72 shown in FIG. 6) of the foundation from a vertical position (e.g., shown in FIG. 5) to a horizontal position (e.g., shown in FIG. 7) thereby arresting the vertical upward motion of the foundation through the seabed.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A deeply embedded anchor installable in a seabed positioned beneath a water column, the deeply embedded anchor comprising:
a foundation connectable to a follower for installing the foundation beneath the seabed, the foundation comprising:
a foundation body extending longitudinally between a first end and an opposing second end; and
a keying flap assembly comprising one or more flaps pivotably coupled to the foundation body, wherein each of the one or more flaps are pivotable relative to the foundation body between a vertical position corresponding to a run-in configuration of the deeply embedded anchor and a horizontal position angularly spaced from the vertical position and corresponding to an installed configuration of the deeply embedded anchor.

2. The deeply embedded anchor of claim 1, wherein the one or more flaps are positioned in an interior of the foundation body.

3. The deeply embedded anchor of claim 2, wherein the one or more flaps cover at least 90% of a cross-sectional area of the interior of the foundation when the one or more flaps are in the horizontal position.

4. The deeply embedded anchor of claim 1, wherein the foundation body comprises a flap support structure through which the keying flap assembly is coupled to the foundation body.

5. The deeply embedded anchor of claim 4, wherein the flap support structure is located at the second end of the foundation body.

6. The deeply embedded anchor of claim 4, wherein the flap support structure is located in an interior of the foundation body.

7. The deeply embedded anchor of claim 6, wherein the flap support structure is cruciform in shape.

8. The deeply embedded anchor of claim 4, wherein the foundation comprises one or more pivot joints connected between the flap support structure and the one or more flaps.

9. The deeply embedded anchor of claim 4, wherein the flap support structure delimits motion of the one or more flaps in response to the one or more flaps pivoting from the vertical position to the horizontal position.

10. The deeply embedded anchor of claim 1, further comprising the follower, wherein the follower is connected to the foundation when the deeply embedded anchor is in the run-in configuration and is disconnected from the foundation when the deeply embedded anchor is in the installed configuration.

11. A moored floating structure, comprising:
a floating support structure;
the deeply embedded anchor of claim 1; and
one or more flexible mooring lines extending between the floating support structure and the deeply embedded anchor.

12. The moored floating structure of claim 11, further comprising an industrial asset supported on the floating support structure.

13. A deeply embedded anchor installable in a seabed positioned beneath a water column, the deeply embedded anchor comprising:
a foundation connectable to a follower for installing the foundation beneath the seabed, the foundation comprising:
a foundation body comprising an interior and extending longitudinally between a first end and an opposing second end; and
a keying flap assembly comprising one or more flaps pivotably coupled to the foundation body, wherein each of the one or more flaps are shiftable relative to the foundation body between a first position corresponding to a run-in configuration of the deeply embedded anchor and a second position spaced from the first position and corresponding to an installed configuration of the deeply embedded anchor in which the one or more flaps cover at least 90% of the surface area of the interior of the foundation body.

14. The deeply embedded anchor of claim 13, wherein the one or more flaps are located in an interior of the foundation body.

15. The deeply embedded anchor of claim 13, wherein the foundation body comprises a flap support structure through which the keying flap assembly is coupled to the foundation body.

16. A moored floating structure, comprising:
a floating support structure;
the deeply embedded anchor of claim 13; and
one or more flexible mooring lines extending between the floating support structure and the deeply embedded anchor.

17. The moored floating structure of claim 16, further comprising an industrial asset supported on the floating support structure.

18. A method for installing a deeply embedded anchor of a moored floating structure in a seabed positioned beneath a column of water, the method comprising:
(a) lowering the deeply embedded anchor towards the seabed whereby a foundation of the deeply embedded anchor penetrates into and through the seabed;
(b) applying a vertically upwards force to the deeply embedded anchor following (a) to drive the foundation vertically upwards through the seabed; and
(c) pivoting in response to (b) one or more flaps of the foundation from a vertical position to a horizontal position thereby arresting the vertical upward motion of the foundation through the seabed.

19. The method of claim 18, wherein the one or more flaps are positioned in an interior of the foundation.

20. The method of claim 19, wherein the one or more flaps cover at least 90% of a cross-sectional area of the interior of the foundation when the one or more flaps are in the horizontal position.
